(19) United States
(12) Patent Application Publication
(10) Pub. No.: US 2026/0120210 A1
(43) Pub. Date: Apr. 30, 2026

(54) Financial Education System and Method of Use

(71) Applicant: Crystal Evans, West Norristown, PA (US)

(72) Inventor: Crystal Evans, West Norristown, PA (US)

(21) Appl. No.: 19/351,531

(22) Filed: Oct. 7, 2025

Related U.S. Application Data
(60) Provisional application No. 63/713,124, filed on Oct. 29, 2024.

(51) Int. Cl. G06Q 50/20; G09B 5/06

(52) U.S. Cl. CPC G06Q 50/20; G09B 5/065

(57) ABSTRACT

A financial education system for teaching financial literacy to students and includes a mobile application, a website, and a server hosting a user database, course database, gamification engine, communication module, and analytics module. The system supports creation of multiple school branches, each having a unique URL providing direct access to a branch-specific interface with isolated user interactions, analytics, and course materials. Users may be assigned roles of student, instructor, or administrator, with role-specific interfaces enabling participation in courses, content management, or branch administration. Courses include multimedia lessons, assessments, and gamified activities awarding points, badges, and leaderboard rankings. The gamification engine tracks engagement across single or multiple branches, and the analytics module generates branch-specific and cross-branch performance reports. The communication module provides real-time and asynchronous messaging between users, while the cloud-based architecture synchronizes data across devices and delivers secure, scalable access to financial literacy content or criteria.

### CROSS-REFERENCE TO RELATED APPLICATION

The present application claims priority to, and the benefit of, U.S. Provisional Application No. 63/713,124 which was filed on Oct. 29, 2024 and is incorporated herein by reference in its entirety.

### FIELD OF THE INVENTION

The present invention generally relates to educational technology platforms and digital learning management systems. More specifically, the present invention relates to a financial education system configured to deliver structured financial literacy training through a mobile application and a website, each connected to a cloud-based server hosting multiple interactive learning modules. The invention comprises a multi-branch architecture that enables administrators to create distinct school branches, each associated with a unique URL providing secure, branch-specific access to content, analytics, and user interactions. The system includes a user database for storing authentication credentials, role assignments, and performance records; a course database for storing multimedia financial literacy materials; and a Non-Fiat tokenized rewards and custodial wallets, digital tokens issued strictly for non-fiat, educational use cases, custodial wallets designed for student safety and compliance, peer-to-peer transfers through escrow within the educational environment, optional future transfer or conversion into fiat currency through approved regulatory and banking pathways, and blockchain-secured credentialing, financial simulations, including virtual bank accounts, credit score simulators, and investment sandboxes; gamified mobile-first interface with tokenized rewards (Money Moves Learn Tokens™); blockchain-secured micro-certifications and digital badges; LMS, SIS, SSO, and banking API integrations, and leaderboard rankings. Additional components include a communication module for real-time and asynchronous messaging, and an analytics module for generating performance dashboards. Accordingly, the present disclosure makes specific reference thereto. Nonetheless, it is to be appreciated that aspects of the present invention are also equally applicable to other like applications, devices, and methods of manufacture.

### BACKGROUND

By way of background, financial literacy is an important life skill that enables individuals to make informed decisions regarding budgeting, saving, investing, credit management, and long-term financial planning. When learned at a young age, the financial skills contribute to a person's ability to achieve financial independence and self-sufficiency. However, many schools either do not include financial literacy as a required part of the curriculum or provide only limited instruction on the subject. As a result, students often complete their secondary education without acquiring the fundamental financial skills necessary to navigate adult responsibilities.

Lack of early financial education persists in post-secondary education which leaves many individuals without adequate knowledge to manage personal finances effectively. Authorities and governments offer public assistance to individuals in financial need. While such support is critical for those facing hardship, the current financial literacy systems do not provide preventative financial education. Accordingly, individuals desire a system that educates teenagers and students about financial literacy.

Therefore, there exists a long-felt need in the art for a financial education system that provides comprehensive, engaging, and accessible financial literacy training to students, particularly high school students in grades 9-12. There is a long-standing need for a platform that can deliver structured financial education, while accommodating the needs of multiple schools, districts, and independent learners. Further, there is a need in the art for a system that integrates gamification features such as points, badges, and leaderboards to encourage participation and retention of financial concepts. Furthermore, there is a need for a solution that enables the creation of multiple school branches, each accessible through a unique URL, to isolate content, analytics, and user interactions for improved program management. Finally, there exists a need for a scalable, cloud-based platform that synchronizes data across devices and provides secure, branch-specific educational environments.

The subject matter disclosed and claimed herein, in one embodiment, comprises a financial education system featuring a mobile application, a website, and current financial literacy platforms offer static content, limited simulations, and basic reporting. There exists a need for a system that combines AI-driven instruction, interactive simulations, gamified incentives, real-time analytics, and verifiable credentials in a single integrated platform. The system includes a user database for storing authentication credentials, user roles, course completion records, and engagement metrics. Virtual bank accounts simulate deposits, withdrawals, budgeting, and account management. Credit score simulator reflects real-world scoring mechanics. Investment sandbox allows simulated trading and scenario-based decision-making. Optional APIs connect to real financial institutions for live account integration. The system further comprises a gamification engine configured to assign points, award badges, and generate leaderboards for users within a single school branch and across multiple branches. An analytics module enables administrators to create new school branches, each having a unique URL providing direct access to a branch-specific interface. The branch-specific environment ensures that user data, analytics, and course content remain isolated for that institution.

In one embodiment, the financial education system includes a communication module configured to provide real-time and asynchronous communication between students, instructors, and administrators through text chat, video conferencing, and integrated calendar-based notifications. The analytics module is configured to generate performance dashboards for individual learners, instructors, and school branches, including course completion rates, quiz scores, and leaderboard rankings. In another embodiment, the system supports adaptive course progression, wherein the completion of a course automatically triggers the scheduling of the next course based on the learner's role, prior performance, and program requirements.

In this manner, the financial education system of the present invention addresses longstanding shortcomings in conventional educational approaches to financial literacy by providing a comprehensive, gamified, and branch-specific digital platform. The invention delivers targeted financial literacy education, increases student engagement through competitive elements, and provides administrators with the tools to manage programs across multiple institutions. The system incorporates unique branch URLs, cloud synchronization, and role-specific interfaces, to provide secure, scalable, and customizable deployment in diverse educational settings. The platform enhances the quality, accessibility, and effectiveness of financial literacy education for learners.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a financial education system. The financial education system includes a mobile application that is configured to be executed on a mobile device, and a website that is accessible through a web browser on an internet-enabled device. The system further includes a server that is communicatively coupled to the mobile application and the website through a network. The server comprises a user database that is configured to store authentication credentials, user role information, course completion data, and gamification points for a plurality of users. The server further comprises a course database that is configured to store educational content and course metadata for a plurality of courses. The server is configured to create a plurality of school branches within the financial education system and to generate, for each school branch, a unique URL associated with that school branch. The unique URL provides direct access to a branch-specific interface.

The server also comprises a gamification engine that is configured to assign points, award badges, and generate leaderboards for users within a school branch and across multiple school branches. The server also comprises a communication module that is configured to provide real-time and asynchronous messaging between users of the same school branch. The server further comprises an analytics module that is configured to generate branch-specific and cross-branch performance reports.

In another embodiment, an analytics module is configured to process user activity data to generate visual dashboards showing course completion rates, quiz performance, and other performance metrics, including aggregated statistics for each school branch.

In one embodiment, a method for initiating use of a financial education system comprises the steps of receiving a registration request from a school or an individual user, wherein the registration request is submitted through a mobile application or a website, creating a user account corresponding to the registrant, wherein the account creation process includes generating authentication credentials, assigning a user role of student, instructor, or administrator, and linking the account to a specific school branch when applicable. The method further comprises assigning one or more courses to the created user account, wherein the assignment is performed automatically based on the user's role, grade level, or enrollment selection, or manually by an instructor or administrator. The method further includes enabling access to the assigned courses through a user dashboard within the mobile application or the website, thereby enabling immediate participation in financial literacy learning activities.

In yet another embodiment, a method for completing a course in a financial education system comprises the steps of enabling a learner to access course content through a user interface displayed by a mobile application or a website, wherein the course content comprises multimedia lessons, downloadable resources, interactive exercises, and financial literacy simulations. The method further comprises enabling the learner to complete one or more assessments associated with the course, wherein the assessments include quizzes, written assignments, interactive problem-solving tasks, or financial goal-setting exercises, and processing results from the assessments to determine performance scores. The method further includes the Student Layer: lesson completion, quizzes, simulations which triggers Money Moves Learn Tokens™, the Platform Layer: AI Tutor, simulations, gamification, analytics Dashboards, the Integration Layer: LMS/SIS/SSO, Banking APIs, Scholarship Engine, Credentialing Layer: Blockchain micro-certifications and badges, and the Rewards Layer: In-platform marketplace, partner rewards, scholarships, optional fiat conversion. The method further comprises issuing a certification to the learner upon satisfying course completion requirements, wherein the certification is stored digitally in the learner's profile and optionally made available for download or sharing.

In still another embodiment, an administrator creates a new school branch through an administrative user interface, wherein details such as school name, location, subscription plan, and administrative contacts are entered. The method further comprises District/Policy Reports: Board-ready and legislative-ready output using anonymized student data.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exemplary system architecture of the financial education system of the present invention in accordance with the disclosed structure;

FIG. 2 illustrates an exemplary method flow for initiating use of the financial education system of the present invention in accordance with the disclosed architecture;

FIG. 3. Illustrates an exemplary process flow for completing a course in the financial education system of the present invention in accordance with the disclosed architecture;

FIG. 4 illustrates an exemplary process flow for administrative management of courses and analytics in the financial education system of the present invention in accordance with the disclosed architecture;

FIG. 5 illustrates an exemplary process flow for creating and configuring a new school branch in the financial education system of the present invention in accordance with the disclosed architecture;

FIG. 6 illustrates an exemplary process flow for adaptive course progression for learners in the financial education system of the present invention in accordance with the disclosed architecture;

FIG. 7 illustrates an exemplary login user interface displayed by the application or website in accordance with disclosed architecture;

FIG. 8 illustrates an exemplary course selection and progress tracking interface displayed by the application or website in accordance with disclosed architecture;

FIG. 9 illustrates an exemplary school management interface displayed by the application or website in accordance with disclosed architecture;

FIG. 10 illustrates an exemplary quiz and gamification interface displayed by the application or website in accordance with disclosed architecture; and

FIG. 11 illustrates an exemplary unique school URL login interface displayed by the application or website in accordance with disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a financial education system that provides comprehensive, engaging, and accessible financial literacy training to students, particularly high school students in grades 9-12. There is a long-standing need for a platform that can deliver structured financial education, while accommodating the needs of multiple schools, districts, and independent learners. Further, there is a need in the art for a system that integrates gamification features such as points, badges, and leaderboards to encourage participation and retention of financial concepts. Furthermore, there is a need for a solution that enables the creation of multiple school branches, each accessible through a unique URL, to isolate content, analytics, and user interactions for improved program management. Finally, there exists a need for a scalable, cloud-based platform that synchronizes data across devices and provides secure, branch-specific educational environments.

The present invention, in one exemplary embodiment, is a method for completing a course in a financial education system and comprises the steps of enabling a learner to access course content through a user interface displayed by a mobile application or a website, wherein the course content comprises multimedia lessons, downloadable resources, interactive exercises, and financial literacy simulations. The method further comprises enabling the learner to complete one or more assessments associated with the course, wherein the assessments include quizzes, written assignments, interactive problem-solving tasks, or financial goal-setting exercises, and processing results from the assessments to determine performance scores. The method further includes awarding points to the learner based on assessment performance and participation in additional course-related activities, wherein the points are tracked by a gamification engine and contribute to leaderboard rankings, Credentials↔Student (Blockchain-secured). The method further comprises issuing a certification to the learner upon satisfying course completion requirements, wherein the certification is stored digitally in the learner's profile and optionally made available for download or sharing.

Reference will now be made in detail to the present preferred embodiments of the invention, examples of which are illustrated in the accompanying drawings. Wherever possible, the same reference numerals are used in the drawings and the description to refer to the same or like parts.

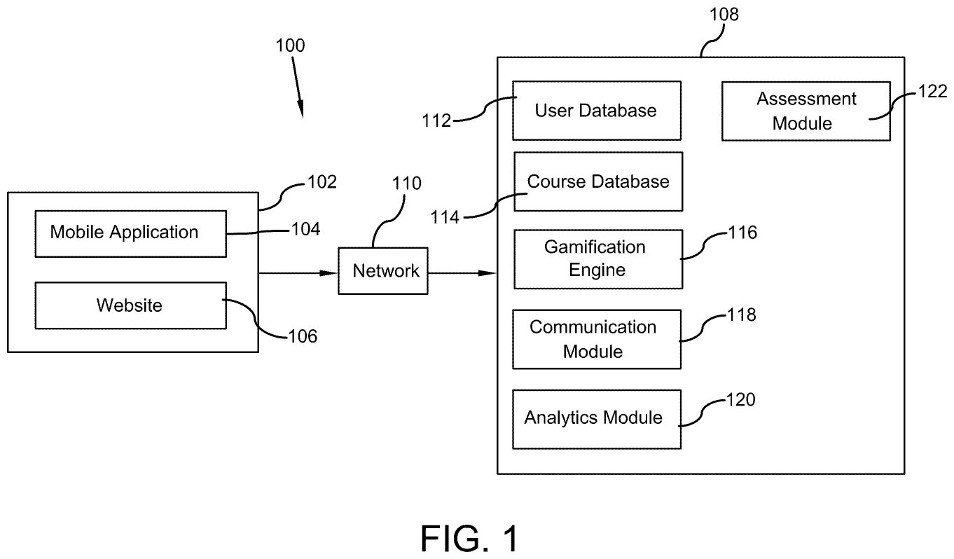

Referring initially to the drawings, FIG. 1 illustrates an exemplary system architecture of the financial education system of the present invention in accordance with the disclosed structure. The financial education system 100 of the present invention is designed as an educational platform to teach school students, preferably high school students (i.e., grades 9-12) about financial literacy. The financial education system 100 combines mobile/web software with interactive gamification to enhance engagement and learning outcomes. More specifically, the financial education system 100 includes a mobile application 104 installed on a mobile device 102. The mobile device 102 can be a smartphone, tablet, smartwatch, or other portable computing device. The financial education system 100 also provides a website 106 which can be accessed through a web browser on any internet-enabled device. Both the mobile application 104 and website 106 are configured to provide a plurality of user interfaces for accessing financial literacy content or criteria, performing assignments, participating in competitive trivia, and engaging in other educational activities. It should be noted that the functionalities offered by the mobile application 104 can also be accessible on the website 106 in the same manner, thereby enhancing the accessibility of the financial education system 100.

The financial education system 100 includes a server 108 which can be a cloud server, distributed server, or a centralized server. The server 108 is configured to host a plurality of backend components of the financial education system 100 and is connected to the mobile device 102 through the network 110, which may comprise a public network such as the Internet, a wireless network, a private network, or a combination thereof.

The server 108 includes a user database 112 that is configured to store and manage user-related information for all registered participants of the financial education system 100. The stored data may include, but is not limited to username, email address, encrypted password, and authentication credentials of each user. A user in the financial education system 100 can have a role of a student, instructor, or administrator, and accordingly, a user role for each user is stored in the user database 112. The user database 112 may also store completed courses, earned points, badges, certifications, and assessment scores of each user registered as a student. The user database 112 may be implemented using a relational or NoSQL cloud-based database and uses secure encryption protocols for security of data.

A course database 114 stores structured and unstructured educational content including course metadata such as course titles, descriptions, target grade levels, and associated school branch. The course database 114 also stores course learning materials such as videos, audio files, slide decks, assignments, quizzes, and downloadable resources for each course. The course database 114 is configured to maintain archives of prior versions of course materials for auditability and compliance. The course database 114 enables secure retrieval by the mobile application 104 and website 106 and supports real-time content updates by instructors through the administration interface as described later in the disclosure.

A gamification engine 116 is configured to administer the engagement of the financial education system 100 and is adapted to assign points for completing courses, assignments, trivia, and quizzes. The gamification engine 116 calculates and displays rankings of students within a school branch, across multiple branches, and globally. The gamification engine 116 also provides additional content such as bonus courses or bonus points based on user activity patterns.

A communication module 118 enables real-time and asynchronous communication between users (i.e., students, instructors, and administrators). The communication module 118 provides secure messaging interface between students and instructors, or within study groups along with live one-on-one coaching sessions and group webinars. The communication module 118 is also configured to sync course schedules and reminders with external calendar services, thereby providing automatic reminders to students about various enrolled courses.

Specifically, the communication module 118 includes a calendar synchronization functionality or mechanism configured to integrate the financial education system 100 with one or more external calendar services, such as Google Calendar, Microsoft Outlook, Apple Calendar, or any other similar service. The calendar synchronization mechanism transmits scheduled events from the financial education system 100 to an external calendar and to receive event updates from the external calendar for display within the mobile application 104 or website 106.

In operation, when a dated event is created or modified in the financial education system 100, the event is mapped to a standard iCalendar format (ICS) and transmitted to the linked external calendar account of the user. The external event may include a title, start and end times, description, location, reminders, recurrence rules, and a unique identifier.

An analytics module 120 processes data generated by various modules of the financial education system 100 to generate actionable insights for students, instructors, and administrators. The analytics module 120 provides visual dashboards showing course completion rates, quiz performance, and goal achievement for each student. The analytics module 120 also provides aggregated statistics for each school branch, including top performers, course popularity, and leaderboard summaries.

The financial education system 100 uses District/Policy Reports: Board-ready and legislative-ready output using anonymized student data in the analytics module 120 for AI-driven predictions on student dropout risks or performance trends, thereby providing real-time feedback for improving financial literacy of the enrolled students. The analytics module 120 also enables administrators to create new school branches, each having a unique URL providing direct access to a branch-specific interface. The branch-specific environment ensures that user data, analytics, and course content remain isolated for that institution.

An assessment module 122 is configured to administer quizzes, surveys, score responses, and records assessment results for tracking learner comprehension and awarding certifications. The assessment module 122 is directly coupled to the courses database 114 for comparison of the recorded assessment results with the target grade levels of each course.

In operation, the mobile device 102 communicates with the server 108 through the network 110. The mobile application 104 or website 106 transmits user requests such as accessing a course content or submitting completed assignments to the server 108, which processes the requests using various modules as described above and returns the results to the user interface in real-time.

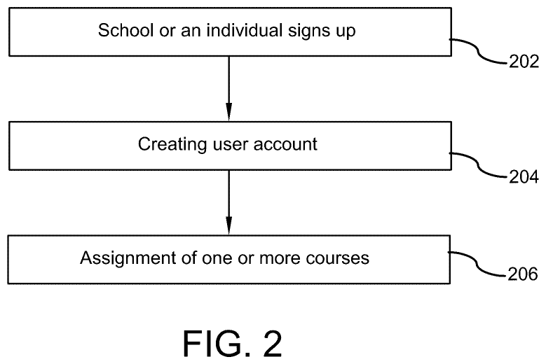

FIG. 2 illustrates an exemplary method flow for initiating use of the financial education system of the present invention in accordance with the disclosed architecture. Initially, a school or an individual user signs up for using the financial education system 100 for financial literacy education (Step 202). In the case of a school sign-up, an administrator may register the institution by providing school information, desired subscription tier, and contact credentials. In the case of an individual sign-up, a user may register directly through the mobile application or website.

Then, the financial education system 100 creates a user account corresponding to the registrant (Step 204). The account creation process may include generating authentication credentials, assigning a user role (i.e., student, instructor, or administrator), and linking the account to a specific school branch (if school is registered).

Finally, the financial education system 100 assigns one or more courses to the created user account (Step 206). The course assignment may be performed automatically based on the user's role, grade level, or enrollment selection, or manually by an instructor or administrator. The assigned courses can be accessed through the user's dashboard within the application, enabling immediate participation in learning activities.

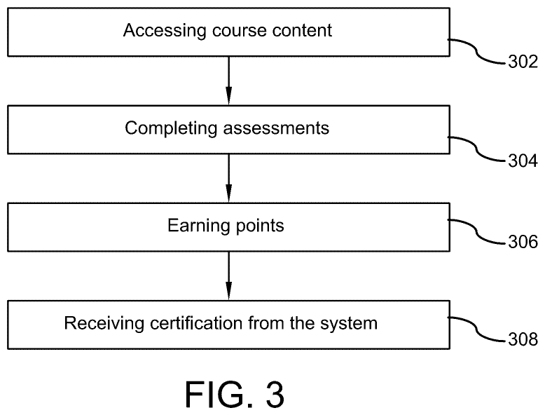

FIG. 3 illustrates an exemplary process flow for completing a course in the financial education system of the present invention in accordance with the disclosed architecture. Initially, a learner (i.e., student) accesses course content through a user interface displayed by the application 104 website 106 (Step 302). The course content or criteria can include multimedia lessons, downloadable resources, interactive exercises, and financial literacy simulations. Content can be accessed sequentially or as assigned by an instructor or the system's automated scheduling feature.

Then, the learner completes one or more assessments associated with the course (Step 304). The assessments may include quizzes, written assignments, interactive problem-solving tasks, or practical financial goal-setting exercises. Results from the assessments are processed by the assessment module to determine performance scores.

Thereafter, the learner earns points based on assessment performance and participation in additional course-related activities such as completing assignments, accessing supplementary materials, or engaging in trivia challenges (Step 306). The points are tracked by the system's gamification engine and may contribute to leaderboard rankings.

Finally, the learner receives a certification from the financial education system 100 upon satisfying the course completion requirements (Step 308). The certification issuance may be triggered automatically when the learner achieves the required passing score, completes all required activities, and meets any attendance or engagement thresholds. The certification may be stored digitally in the learner's profile and optionally made available for download or sharing.

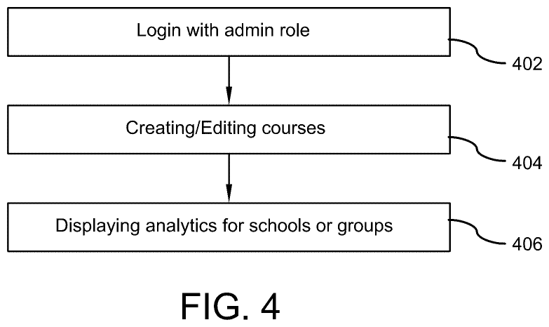

FIG. 4 illustrates an exemplary process flow for administrative management of courses and analytics in the financial education system of the present invention in accordance with the disclosed architecture. Initially, a user logs into the system with an administrator role (Step 402). The administrator role may be assigned to school officials or super admins responsible for managing multiple branches. Upon login, the financial education system 100 verifies the administrator's credentials and grants access to administrative tools and dashboards.

Then, the logged in administrator creates or edits one or more courses (Step 404). The course creation process may include uploading multimedia content, defining learning objectives, setting prerequisites, creating assessments, and scheduling release dates for lessons. The editing process may involve updating course materials, modifying deadlines, or adjusting assessment criteria. It should be noted that the administrator can work with one or more instructors to create and edit the courses.

Finally, the financial education system 100 displays analytics for schools or groups associated with the administrator's account (Step 406). The analytics may include student enrollment statistics, course completion rates, average assessment scores, engagement levels, and leaderboard summaries. The administrator can use these analytics to evaluate program effectiveness, identify areas for improvement, and make data-driven decisions regarding course content and delivery.

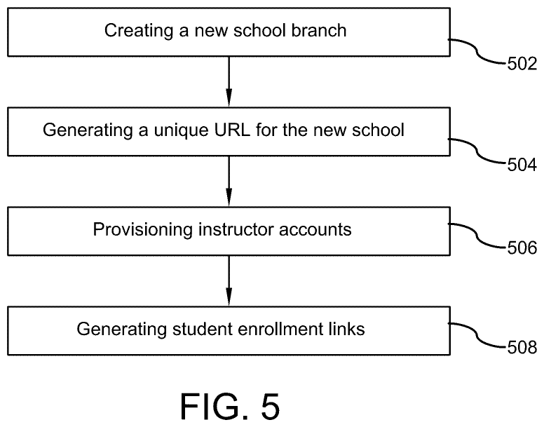

FIG. 5 illustrates an exemplary process flow for creating and configuring a new school branch in the financial education system of the present invention in accordance with the disclosed architecture. Initially, an administrator through the personalized administrative user interface, creates a new school branch for financial literacy (Step 502). Details such as school name, location, subscription plan, and administrative contacts may be entered for creating the new school branch.

Then, a unique URL is generated for the new school branch (Step 504). The URL may be in the form of a subdomain or a uniquely parameterized link, enabling direct access to the branch-specific interface. The unique URL enables isolation of all user interactions, analytics, and course materials to the designated school branch.

Thereafter, one or more instructor accounts are associated with the newly created school branch (Step 506). The instructor accounts may include generating login credentials, assigning teaching roles, linking instructors to specific course categories, and setting administrative permissions.

Finally, student enrollment links for the new branch are automatically generated (Step 508). The enrollment links may be distributed by the school administration to enable students to self-register into the branch-specific environment. The students may be guided through an onboarding process and automatically associated with the correct school branch and assigned initial courses. It should be noted that URL generation can be facilitated by the analytics module 120 (FIG. 1) which may have an embedded branch management functionality.

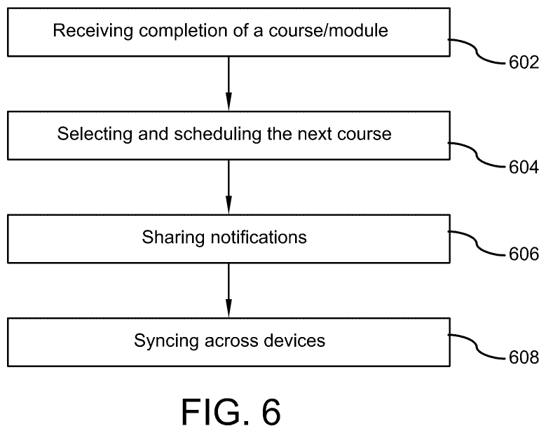

FIG. 6 illustrates an exemplary process flow for adaptive course progression for learners in the financial education system of the present invention in accordance with the disclosed architecture. Initially, a confirmation of the completion of a course or module by a learner is received by the system (Step 602). The confirmation may be triggered automatically when all lessons, assessments, and required activities for the course are completed and recorded in the user database.

Then, the next course is selected and scheduled for the learner (Step 604). The selection process may be based on predefined learning paths, the learner's grade level, prior performance, and chosen specialization areas. The scheduling may include a configurable delay period between course assignments or may enable immediate access to the next module.

Upon selection and schedule of the next course, a notification to inform the learner of the newly scheduled course is generated (Step 606). The notification may be delivered through in-app alerts, push notifications on mobile devices, email messages, or calendar event updates. The notification content may include the course title, start date, and links to course learning materials. Finally, the system synchronizes the course update in the user database 112 and across all devices associated with the learner's account (Step 608).

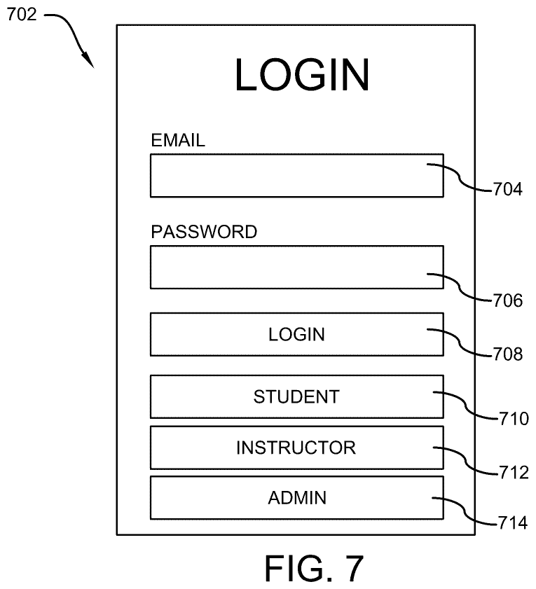

FIG. 7 illustrates an exemplary login user interface displayed by the application or website in accordance with disclosed architecture. The interface 702 includes an email input field 704 for entering the user's registered email address and a password input field 706 for entering a corresponding authentication password. A login button 708 is provided to initiate the login process after credentials are entered.

The interface 702 also displays a plurality of distinct role-selection buttons to enable the user to specify the type of account to be accessed. A student role button 710 enables access to the learner-specific interface, including course listings, progress tracking, and gamification features. An instructor role button 712 provides access to course management tools, grading modules, and communication features for interacting with learners. An admin role button 714 grants access to administrative functionalities such as branch management, course assignments, and analytics dashboards.

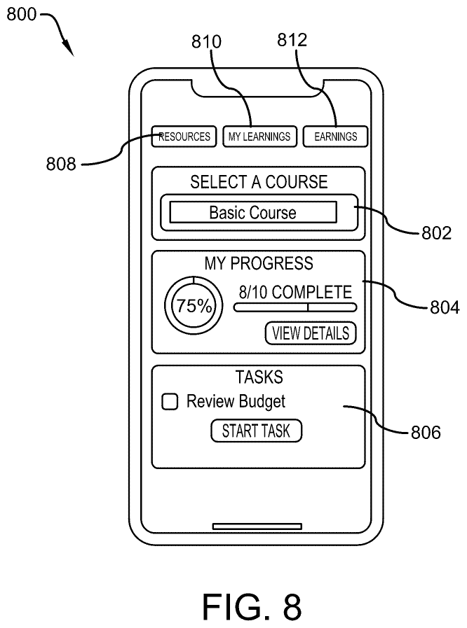

FIG. 8 illustrates an exemplary course selection and progress tracking interface displayed by the application or website in accordance with disclosed architecture. The interface includes a course selection area 802 configured to display a list or dropdown menu of available courses for the learner. In the present embodiment, a course titled “Basic Course” is shown as selected and the learner can choose any available course as per their preference.

A progress tracking area 804 provides visual feedback on the completion status for the selected course of the learner and includes a percentage indicator, a numerical progress count (i.e., “8/10 COMPLETE”) for number of courses completed, and a “VIEW DETAILS” button for accessing additional progress metrics. A task area 806 lists pending tasks associated with the selected course. Each task may include a checkbox for marking completion and an associated “START TASK” button to launch the activity.

The interface 800 displays a “Resource” tab 808 which provides a centralized repository of educational and financial literacy materials related to the enrolled courses of the learner. The “Resource” tab 808 may provide instructional videos, audio lectures, presentations, articles, e-books, downloadable PDFs, reference guides, and more.

A “MY LEARNINGS” section 810 may provide a personalized dashboard for managing and tracking educational activities. The section 810 may provide list of active courses with current progress indicators, course completion status and percentage-based visual progress bars, upcoming lessons and deadlines, integrated with the in-app calendar, and assessment history. An “EARNINGS” section 812 may gamify the learning process by tracking engagement-based rewards and achievements. The “EARNINGS” section 812 may provide badges and achievements for specific milestones, Leaderboard rankings, and points tally.

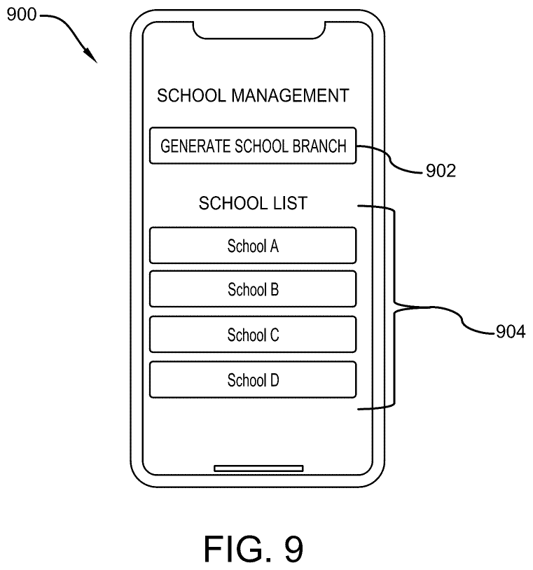

FIG. 9 illustrates an exemplary school management interface displayed by the application or website in accordance with disclosed architecture. The interface 900 includes a generate school branch control 902, which, when selected, initiates a process for creating a new school branch within the system. The process may include entering school information, selecting a subscription plan, and generating a unique URL for the new branch.

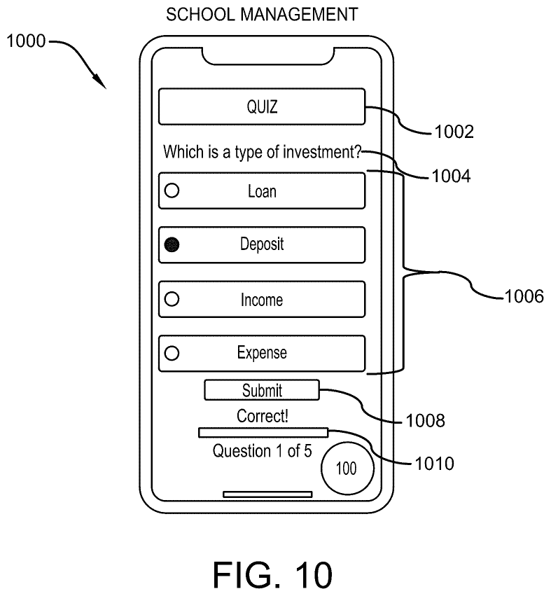

A school list display area 904 is provided to display the names of existing schools or branches currently associated with the administrator's account. Each listed school entry may be selectable to enable the administrator to access branch-specific management features, including course assignments, instructor provisioning, student enrollment tracking, and analytics reporting. FIG. 10 illustrates an exemplary quiz and gamification interface displayed by the application or website in accordance with disclosed architecture. The interface 1000 displays a quiz title area 1002, indicating that the current activity is a quiz. A quiz question display 1004 presents an exemplary financial literacy question such as “Which is a type of investment?”. It should be noted that different criteria, quizzes, assessments, trivia, and more can be displayed by the interface 1000. Exemplary criteria, quizzes, assessments, or trivia can be chosen from categories including: foundational finances; budgeting and spending; saving and investing; debt and credit; protection and risk management; and financial planning and goals. The foundational finances can include questions selected from the group consisting of: What does financial literacy mean to you? What are the five principles of financial literacy (earning, saving/investing, protecting, spending/budgeting, borrowing/managing debt)? Explain the concept of compound interest. What is the relationship between interest rates and inflation? How do you differentiate between needs and wants when it comes to spending? What is the difference between a debit card and a credit card? The budgeting and spending concept can include questions selected from the group consisting of: How often do you create and follow a personal budget? What methods or tools do you use to track your spending? How do you adjust your budget to accommodate unexpected expenses? What percentage of your income do you typically save each month? How do you prioritize your expenses, especially when facing limited funds? The saving and investment concept can include questions selected from the group consisting of: What are the benefits of maintaining an emergency fund, and how much should it ideally contain? Which is a type of investment? What are some different types of investment options (stocks, bonds, mutual funds, etc.) and what are their associated risks and potential returns? How do you assess market trends or research investment options before making a decision? What are your long-term investment goals (e.g., retirement, buying a home)? The debt and credit concept can include questions selected from the group consisting of: How does your credit score work and what factors influence it? What are some effective strategies for managing debt, such as student loans or credit card balances? What are the potential consequences of carrying high levels of debt or making late payments? Under what circumstances would it be financially beneficial to borrow money? The protection and risk management can include questions selected from the group consisting of: Why is having insurance important, and what types of insurance do you believe are essential? How do you protect yourself from identity theft and financial fraud? What measures do you take to safeguard your financial information and online accounts? The financial planning and goals concept can include questions selected from the group consisting of: What are your primary financial goals for the next five years? How does financial planning factor into your decision-making process for major life events (e.g., buying a car, purchasing a home)? What resources do you rely on to learn about financial topics and make informed decisions? How confident do you feel about managing your finances and achieving your financial goals?

A multiple-choice answer section 1006 presents selectable answer options, each option is associated with a radio button for user selection to check financial literacy of the learner. A submit button 1008 enables the learner to confirm their selected answer. Upon submission, the system evaluates the response and provides immediate feedback. In the example shown, the feedback “CORRECT!” is displayed, indicating the answer is correct. A quiz progress indicator 1010 shows position of the learner within the quiz sequence, for example, “QUESTION 1 OF 5,” and may also display the learner's current score or points earned. Advanced gamification features can comprise experience points (XP) progression, streak tracking and milestone rewards, adaptive difficulty based on performance, a non-fiat token store for redeemable educational rewards, and tiered badges with progression levels.

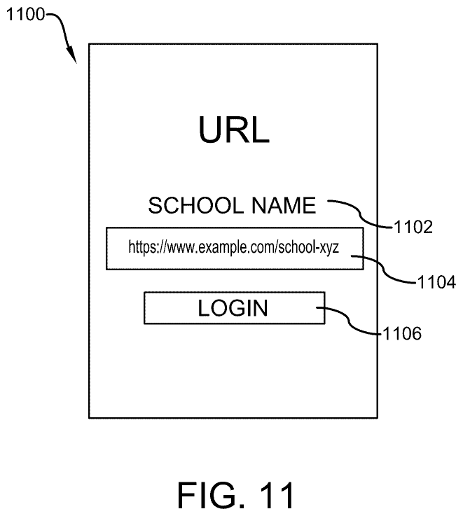

FIG. 11 illustrates an exemplary unique school URL login interface displayed by the application or website in accordance with disclosed architecture. The interface 1100 includes a school name display area 1102, which identifies the institution or branch for the login session. A URL field 1104 shows the unique web address generated for the school branch and the URL may be automatically populated when accessed through the branch-specific link or entered manually by the user.

A login button 1106 is provided to initiate the authentication process for the selected school branch. Upon activation, the financial education system 100 directs the user to the appropriate login interface such as a student, instructor, or administrator login (FIG. 7). It is to be appreciated that fiat currency can be converted into non-fiat tokenized rewards (i.e., digital tokens) for custodial wallets. Digital tokens can be used for non-fiat, educational use cases and the custodial wallets provides for student safety and compliance. Peer-to-peer transfers through escrow within the educational environment can provide the means to transfer or convert non-fiat currency into fiat currency (and vice versa) through approved regulatory and banking pathways. The system can further be configured to restrict tokens to non-cash and educational use cases to ensure compliance with student protection and regulatory requirements. Financial simulators can be initiated to imitate and educate in the areas of budgeting, investments, loans and credit, college costs, and financial aid, wherein each simulator can dynamically adjust scenario outcomes based on user input, course progress, and real-world financial data. Student-centered experiences can comprise moderated social feeds for peer interaction, personalized learning pathways by learning style, dedicated math practice centers for financial formulas, and interactive lesson tabs (i.e., vocabulary, formulas, activities, discussion). Administrative and institutional tools can comprise real-time retention dashboards, school renewal and program continuation kits, sponsor and partner portals, impact reporting dashboards for compliance and funding. Compliance and safety features can comprise FERPA, COPPA, and K-12 digital compliance integration, safeguards for custodial wallets, and non-fiat token issuance models to avoid classification as cash equivalents. Educator training and certification can comprise facilitator certification and licensing platforms, national educator training pipelines, peer mentorship and professional development modules. Acquisition and banking integration readiness can comprise CRA (i.e., banking) compliant reporting, impact scoring, and data structures supporting future banking partnerships and acquisitions.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “financial education system”, “financial literacy training system”, “cloud-based financial education system”, and “system” are interchangeable and refer to the financial literacy training system 100 of the present invention.

Notwithstanding the forgoing, the financial literacy training system 100 of the present invention can be of any suitable configuration as is known in the art without affecting the overall concept of the invention, provided that it accomplishes the above stated objectives. One of ordinary skill in the art will appreciate that the financial literacy training system 100 as shown in the FIGS. are for illustrative purposes only, and that many other configurations of the financial literacy training system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A financial education system comprising:
a mobile application;
a mobile device;
a website;
a server;
a course database;
a gamification engine;
a communication module;
an analytics module; and
an assessment module;
wherein said mobile application comprises interactive said gamification engine to enhance engagement and learning outcomes;
wherein said mobile device is selected from the group consisting of a smartphone, a tablet, a smartwatch, and a portable computing device;
wherein said website is accessed through a web browser;
wherein said mobile application and said website comprise a plurality of user interfaces selected from the group consisting of accessing financial literacy concept, performing assignments, participating in competitive trivia, and engaging in educational activities;
wherein said assessing financial literacy selected from one or more of the criteria consisting of foundational finances, budgeting and spending, saving and investing, debt and credit, protection and risk management, and financial planning and goals;
wherein said server comprises a user database including user-related stored data for all registered participants of the financial education system;
wherein said stored data is selected from the group consisting of usernames, email addresses, encrypted passwords, and authentication credentials of each user;
wherein said user of the financial education system is selected from the group consisting of a student, an instructor, and an administrator; and
further wherein said user database stores information selected from the group consisting of completed courses, earned points, badges, certifications, and assessment scores of each user registered as said student.

2. The financial education system of claim 1, wherein said foundational finances criteria includes one or more questions selected from the group consisting of: what does financial literacy mean to you, what are the five principles of financial literacy, explain the concept of compound interest, what is the relationship between interest rates and inflation, how do you differentiate between needs and wants when it comes to spending, and what is the difference between a debit card and a credit card.

3. The financial education system of claim 2, wherein said budgeting and spending criteria includes one or more questions selected from the group consisting of: how often do you create and follow a personal budget, what methods do you use to track your spending, how do you adjust your budget to accommodate unexpected expenses, what percentage of your income do you typically save each month, and how do you prioritize your expenses.

4. The financial education system of claim 3, wherein said saving and investment criteria includes one or more questions selected from the group consisting of: what are the benefits of maintaining an emergency fund, how much should said emergency fund contain, which is a type of investment, what are some different types of investment options, what are the associated risks and potential returns of said investment options, how do you assess market trends, and what are your long-term investment goals.

5. The financial education system of claim 4, wherein said debt and credit criteria includes one or more questions selected from the group consisting of: how does your credit score work, what are some effective strategies for managing debt, what are the consequences of carrying high levels of debt, what are the consequences of making late payments, and under what circumstances would it be financially beneficial to borrow money.

6. The financial education system of claim 5, wherein said protection and risk management criteria includes one or more questions selected from the group consisting of: why is having insurance important, what types of insurance are essential, how do you protect yourself from identity theft and financial fraud, and what measures do you take to safeguard your financial information and online accounts.

7. The financial education system of claim 6, wherein said financial planning and goals criteria includes one or more questions selected from the group consisting of: what are your primary financial goals for the next five years, how does financial planning factor into your decision-making process for major life events, what resources do you rely on to learn about financial topics and make informed decisions, and how confident do you feel about managing your finances and achieving your said primary financial goals.

8. The financial education system of claim 7, wherein said course database stores educational content of a course selected from the group consisting of course metadata, course titles, course descriptions, course target grade levels, and associated school branches, and further wherein said course database further stores course materials selected from the group consisting of videos, audio files, slide decks, assignments, quizzes, and downloadable resources for each said course.

9. The financial education system of claim 8, wherein said gamification engine is configured to administer the engagement of the financial education system and to assign points for completing courses, assignments, trivia, and quizzes, and further wherein said gamification engine displays rankings of said students within a school branch, across multiple branches, and globally.

10. The financial education system of claim 9, wherein said communication module provides real-time and asynchronous communication between said students, said instructors, and said administrators.

11. The financial education system of claim 10, wherein said communication module syncs course schedules with external calendar services, wherein said communication module comprises a calendar synchronization to integrate the financial education system with one or more external calendars selected from the group consisting of a Google Calendar, a Microsoft Outlook, and an Apple Calendar, and further wherein said calendar synchronization transmits scheduled events from the financial education system to said external calendars and to receive event updates from said external calendars for display within said mobile application.

12. The financial education system of claim 11, wherein said analytics module provides visual dashboards displaying information selected from the group consisting of course completion rates, quiz performances, and goal achievements for each said student.

13. The financial education system of claim 12, wherein said analytics module provides aggregated statistics for each said school branch selected from the group consisting of a top performers, a course popularity, and a leaderboard summary.

14. The financial education system of claim 13, wherein said assessment module is configured to administer quizzes, administer surveys, score responses, and record assessment results, and further wherein said assessment module is coupled to said course database for comparison of said recorded assessment results with said course target grade levels of each said course.

15. A financial education system comprising:
a mobile application;
a mobile device;
a website;
a server;
a course database;
a gamification engine;
a communication module; and
an analytics module;
wherein said mobile application comprises interactive said gamification engine to enhance engagement and learning outcomes;
wherein said mobile device is selected from the group consisting of a smartphone, a tablet, a smartwatch, and a portable computing device;
wherein said website is accessed through a web browser;
wherein said mobile application and said website comprise a plurality of user interfaces selected from the group consisting of accessing financial literacy concept, performing assignments, participating in competitive trivia, and engaging in educational activities;
wherein said assessing financial literacy selected from one or more of the criteria consisting of foundational finances, budgeting and spending, saving and investing, debt and credit, protection and risk management, and financial planning and goals;
wherein said server comprises a user database including user-related stored data for all registered participants of the financial education system;
wherein said stored data is selected from the group consisting of usernames, email addresses, encrypted passwords, and authentication credentials of each user;
wherein said user of the financial education system is selected from the group consisting of a student, an instructor, and an administrator;
wherein said user database stores information selected from the group consisting of completed courses, earned points, badges, certifications, and assessment scores of each user registered as said student;
wherein said gamification engine is configured to administer the engagement of the financial education system and to assign points for completing courses, assignments, trivia, and quizzes; and
further wherein said gamification engine displays rankings of said students within a school branch, across multiple branches, and globally.

16. The financial education system of claim 15, wherein said course database stores educational content of a course selected from the group consisting of course metadata, course titles, course descriptions, course target grade levels, and associated school branches, and further wherein said course database further stores course materials selected from the group consisting of videos, audio files, slide decks, assignments, quizzes, and downloadable resources for each said course.

17. The financial education system of claim 16, wherein said communication module provides real-time and asynchronous communication between said students, said instructors, and said administrators.

18. The financial education system of claim 17, wherein said analytics module provides aggregated statistics for each said school branch selected from the group consisting of a top performer, a course popularity, and a leaderboard summary.

19. The financial education system of claim 15, wherein said foundational finances criteria includes one or more questions selected from the group consisting of: what does financial literacy mean to you, what are the five principles of financial literacy, explain the concept of compound interest, what is the relationship between interest rates and inflation, how do you differentiate between needs and wants when it comes to spending, and what is the difference between a debit card and a credit card;
wherein said budgeting and spending criteria includes one or more questions selected from the group consisting of: how often do you create and follow a personal budget, what methods do you use to track your spending, how do you adjust your budget to accommodate unexpected expenses, what percentage of your income do you typically save each month, and how do you prioritize your expenses;
wherein said saving and investment criteria includes one or more questions selected from the group consisting of: what are the benefits of maintaining an emergency fund, how much should said emergency fund contain, which is a type of investment, what are some different types of investment options, what are the associated risks and potential returns of said investment options, how do you assess market trends, and what are your long-term investment goals;
wherein said debt and credit criteria includes one or more questions selected from the group consisting of: how does your credit score work, what are some effective strategies for managing debt, what are the consequences of carrying high levels of debt, what are the consequences of making late payments, and under what circumstances would it be financially beneficial to borrow money;
wherein said protection and risk management criteria includes one or more questions selected from the group consisting of: why is having insurance important, what types of insurance are essential, how do you protect yourself from identity theft and financial fraud, and what measures do you take to safeguard your financial information and online accounts; and
further wherein said financial planning and goals criteria includes one or more questions selected from the group consisting of: what are your primary financial goals for the next five years, how does financial planning factor into your decision-making process for major life events, what resources do you rely on to learn about financial topics and make informed decisions, and how confident do you feel about managing your finances and achieving your said primary financial goals.

20. A financial education system comprising:
a mobile application;
a mobile device;
a website;
a server;
a user database; and
a gamification engine;
wherein said mobile application comprises interactive said gamification engine to enhance engagement and learning outcomes;
wherein said mobile device is selected from the group consisting of a smartphone, a tablet, a smartwatch, and a portable computing device;
wherein said website is accessed through a web browser;
wherein said mobile application and said website comprise a plurality of user interfaces selected from the group consisting of accessing financial literacy concept, performing assignments, participating in competitive trivia, and engaging in educational activities;
wherein said assessing financial literacy selected from one or more of the group consisting of foundational finance, budgeting and spending concept, saving and investing concept, debt and credit concept, protection and risk management, and financial planning and goals concept;
wherein said server comprises said user database including user-related stored data for all registered participants of the financial education system;
wherein said stored data is selected from the group consisting of usernames, email addresses, encrypted passwords, and authentication credentials of each user;
wherein said user of the financial education system is selected from the group consisting of a student, an instructor, and an administrator;
wherein said user database stores information selected from the group consisting of completed courses, earned points, badges, certifications, and assessment scores of each user registered as said student;
wherein said gamification engine is configured to administer the engagement of the financial education system and to assign points for completing courses, assignments, trivia, and quizzes;
wherein said gamification engine displays rankings of said students within a school branch, across multiple branches, and globally; and
further wherein said performing assignments is based on a criteria selected from the group consisting of said student's role, said student's grade level, said student's enrollment selection, said instructor's manual assignment, and said administrator's manual assignment.
